(19) United States
(12) Patent Application Publication
(10) Pub. No.: US 2010/0059176 A1
(43) Pub. Date: Mar. 11, 2010

(54) Multilayer Information Recording Medium, and Apparatus and Method for Manufacturing Same

(76) Inventor: Eiichi Ito, Hyogo (JP)

Correspondence Address: WENDEROTH, LIND & PONACK L.L.P., 1030 15th Street, N.W., Suite 400 East, Washington, DC, 20005-1503, US

(21) Appl. No.: 11/887,646

(22) PCT Filed: Mar. 29, 2006
(86) PCT No.: PCT/JP2006/306476

§ 371 Date: Oct. 1, 2007

(30) Foreign Application Priority Data
Apr. 1, 2005 (JP) 2005-105871

(51) Int. Cl. G11B 7/26; B05C 5/00; B05B 13/02; B05C 11/00; B05D 1/02; B32B 38/00

(52) U.S. Cl. 156/281; 118/323; 118/321; 118/708; 427/424; 427/427.3; 427/425

(57) ABSTRACT

The present invention provides an apparatus for fabricating a multi-layer information recording medium including a substrate, plural information recording layers placed on the aforementioned substrate, resin intermediate layers placed between adjacent information recording layers and a resin protective layer placed on all the information recording layers at the side opposite from the aforementioned substrate, the apparatus including an ejecting unit including ink jet nozzles operable to drip minute resin liquid drops onto the aforementioned substrate or the aforementioned information recording layers; and a control unit operable to control the aforementioned ejecting unit, whereby resin layers which form said resin intermediate layers or said resin protective layer are formed on the aforementioned substrate or the aforementioned information recording layers.

### TECHNICAL FIELD

The present application claims priority to Japanese Patent Application No. 2005-105871 filed on Apr. 1 2005, the content of which is incorporated herein by reference.

The present invention relates to an information recording medium for use for replaying and replaying/recording and a fabricating method thereof and, more particularly, relates to a multi-layer information recording medium including two or more information recording layers and an apparatus and a method for fabricating the same.

### BACKGROUND

In recent years, along with increases of the amount of information required to be treated in information apparatuses, image/sound apparatuses and the like, attentions have been focused on information recording mediums, such as optical disk, which can facilitate data accessing, accumulate large capacity data and reduce the sizes of apparatuses, and the densities of recorded information have been increased. As means for increasing the densities of optical disks, for example, there have been realized optical information recording mediums including a single information recording layer and having capacities of about 25 GB and optical information recording mediums including two information recording layers and having capacities of about 50 GB, in cases of using laser light with wavelengths of about 400 nm and pickup heads including a condenser lens with a numerical aperture (NA) of 0.85 for aperture-setting for the laser light. In fabricating methods of optical information recording mediums including two or more information recording layers, there is a need for sophisticated techniques for forming resin intermediate layers for providing constant intervals between adjacent information recording layers. In order to form such rein intermediate layers, it is common to employ spin coating methods, as described in Japanese Patent Laid-open Publication No. 2002-092969, and screen printing methods, as described in Japanese Patent Laid-open Publication No. 9-35336, and the like.

Hereinafter, with reference to FIGS. 19 to 21, there will be described the configuration and the fabricating method of a conventional multi-layer information recording medium. FIGS. 19 (A) to (F) illustrate a method for fabricating a stamper which is a substrate fabricating die for use in fabricating the conventional multi-layer information recording medium. The stamper is applied as follows. At first, a photosensitive material such as a photoresist is formed on a glass plate 201 to form a photosensitive film 202 (see FIG. 19(A)) and, then, patterns such as pits, guide grooves and the like are printed through light exposure through optical recording with laser light 203 (see FIG. 19(B)). There are illustrated, in FIG. 19(B), the portions of the photosensitive film 202a which have been exposed to the light. The photosensitive material is removed from the portions exposed to the light, through development processing, to fabricate an optical recording original substrate 205 having patterns 204 such as pits and guide grooves formed therein (see FIG. 19(C)). The shapes of the patterns 204 such as pits and guide grooves formed in the photosensitive film 202 are transferred to a conductive film 206 formed through sputtering, vapor deposition or other methods (see FIG. 19(D)). Further, in order to increase the rigidity and the thickness of the conductive film 206, a plated film 207 is formed thereon (see FIG. 19(E)). Next, the conductive film 206 and the plated film 207 are exfoliated from the interface between the photosensitive film 202 and the conductive film 206 to complete the fabrication of the stamper 208 (see FIG. 19(F)).

FIG. 20 is a cross-sectional view illustrating the configuration of a conventional multi-layer information recording medium. The multi-layer information recording medium is constituted by a molded rein substrate 301 having, on its one surface, an information surface having concave and convex shaped pits and guide grooves formed through transferring, and plural information recording layers 302 and 304 laminated thereon. In this case, description will be given by referring to the information surface side of the molded resin substrate 301 as an upper side while referring to the opposite side thereof as a lower side. The multi-layer information recording medium is constituted by a 0-th information recording layer 302 placed on the molded resin substrate 301 such that it contacts with the upper side thereof, a first resin intermediate layer 303 which is placed on the 0-th information recording layer 302 such that it contacts with the upper side thereof and has, on its surface opposite from the 0-th information recording layer 302, an information surface having concave and convex shaped pits and guide grooves formed through transferring, a first information recording layer 304 placed on the first resin intermediate layer 303 such that it contacts with the upper side thereof, a transparent substrate 306 placed to face to the first resin intermediate layer 303, and an adhesive layer 305 provided in order to attach the first information recording layer 304 and the transparent substrate 306 to each other.

The molded resin substrate 301 has, on its one surface, an concave and convex shaped information surface having pits and guide grooves formed through transferring using the stamper 208 illustrated in FIG. 19(F) by injection molding or the like thereof. Thin film layers are formed on the information surface to form information recording layers. The molded resin substrate 301 has a thickness of about 1.1 mm. The 0-th information recording layer 302 and the first information recording layer 304 are made of a recording film or a reflective film formed through sputtering, vapor deposition or other methods.

The first resin intermediate layer 303 is made of a resin film formed by performing a spin coating method or a screen printing method on a photo-curing resin, wherein an information surface having concave and convex shaped pits and guide grooves has been formed on the upper side thereof. The information surface is formed as follows. That is, a transfer substrate having, on its one surface, a concave and convex shaped information surface having pits and guide grooves formed through transferring, as the stamper 208 illustrated in FIG. 19(F) and the molded resin substrate 301, is attached to the molded resin substrate 301 such that the information surface thereof is faced to the molded resin substrate 301 with a photo-curing resin interposed therebetween, then the photo-curing resin is optically cured and, then, the transfer substrate is exfoliated from the interface with the photo-curing resin. The transparent substrate 306 is made of a material transparent to recording/replaying light (having transparency) and has a thickness of about 0.1 mm. The adhesive layer 305 is provided for attaching the two substrates 306 and 307 to each other and is made of a photo-curing resin or an adhesive agent such as a pressure sensitive adhesive agent. The recording and replaying of information in and from the multi-layer information recording medium are performed by directing recording/replaying laser light thereto through the transparent substrate 306.

With reference to FIGS. 21(A) to (I), there will be described a conventional fabricating method of a multi-layer information recording medium which employs a spin coating method for forming resin intermediate layers.

On the surface of a molded resin substrate 401 which has a 0-th signal surface constituted by pits and guide grooves formed therein, a 0-th information recording layer 402 including a recording film material or a reflective film material is formed through sputtering, vapor deposition or other methods. The molded resin substrate 401 is secured, at its surface opposite from the surface having the 0-th information recording layer 402 formed thereon, to a rotation table 403, through vacuum suction or other means (see FIG. 21(A)). A photo-curing resin A404 is applied to the 0-th information recording layer 402 on the molded resin substrate 401 secured on the rotation table 403, with a dispenser, in a concentric shape with a desired radius (see FIG. 21(B)) and, then, the photo-curing resin A404 is drawn through spin rotation of the rotation table 403 (see FIG. 21(C)). At this time, the thickness of the photo-curing resin A404 to be drawn can be controlled to a desired thickness by arbitrarily setting the viscosity of the photo-curing resin A404, the rotation speed and the time period of the spin rotation and the ambient atmosphere (the temperature, the humidity and the like) during the spin rotation. After the spin rotation is stopped, the drawn photo-curing resin A404 is cured through irradiation of light with a light irradiation apparatus 405.

Next, in order to form a first information surface on the molded resin substrate 401, a transfer substrate 406 is secured on a rotation table 407 (see FIG. 21(D)), wherein the transfer substrate 406 has, on its one surface, convex and concave shaped pits and guide grooves, as the stamper 208 illustrated in FIG. 19(F) and the molded resin substrate 401 (see FIG. 21(D)). A photo-curing resin B408 is applied to the transfer substrate 406 secured on the rotation table 407, with a dispenser, in a concentric shape with a desired radius (see FIG. 21(E)) and, then, the photo-curing resin B408 is drawn through spin rotation of the rotation table 407 (see FIG. 21(F)). The thickness of the photo-curing resin B408 to be drawn can be controlled to a desired thickness, similarly to the photo-curing resin A404. After the spin rotation is stopped, the drawn photo-curing resin B408 is cured through irradiation of light with a light irradiation apparatus 409.

On the single rotation table 403, two substrates 410 and 411 are laminated such that photo-curing resin layers on the substrates 410 and 411 are faced to each other with a photo-curing resin C412 interposed therebetween (see FIG. 21(G)). Then, the integrated substrates 410 and 411 are subjected to spin rotation with the rotation table 403. The thickness of the photo-curing resin C412 is controlled to a desired thickness through the spin rotation and, then, is cured through light irradiation with a light irradiation apparatus 405 (see FIG. 21(H)). After the substrates 410 and 411 are integrated with each other through the photo-curing resin C412, the transfer substrate 406 is removed from the interface between the transfer substrate 406 and the photo-curing resin B408 to complete the formation of a second information surface on the molded resin substrate 401 (see FIG. 21(I)).

As the photo-curing resin A404 used herein, a photo-curing resin having excellent adhesion to the 0-th information recording layer 402 and the photo-curing resin C412 is selected. Further, as the photo-curing resin B408, a photo-curing resin which has good exfoliation from the transfer substrate 405 and exhibits excellent adhesion to the photo-curing resin C412 is selected.

On the first information surface formed on the molded resin substrate 401, a first information recording layer 413 including a recording film material and a reflective film material is formed through sputtering, vapor deposition or other methods. The adhesive layer 415 formed for attaching the first information recording layer 413 and the transparent substrate 414, which has transparency to recording/replaying light, is formed by applying a photo-curing resin to the first information recording layer 413, then drawing it through spin rotation and then curing it through light irradiation. While there has been described a fabricating method which employs three types of photo-curing resins, there have been also suggested simpler fabricating methods which control the adhesion of the transfer substrate 406 for reducing the number of types of photo-curing resins for use therein.

A multi-layer optical information recording medium fabricating method which forms resin intermediate layers through a spin printing method as described in Japanese Patent Laid-open Publication No. 9-35336 is different from the aforementioned multi-layer optical information recording medium fabricating method, in that screen printing is performed for forming photo-curing resin thin films, instead of the spin coating method used for drawing the photo-curing resins, but the other processes are basically similar to those in the aforementioned fabricating method.

### SUMMARY OF THE INVENTION

However, in the case of forming resin intermediate layers through a spin coating method, it is difficult to form photo-curing resin layers with uniform thicknesses, mainly, since the resin is supplied to only certain areas and the centrifugal force utilized for drawing is varied depending on the radial position. Furthermore, the resin reaches the outer circumferential end surface of the molded resin substrate, which causes the problem of occurrence of bumps at the outermost circumferential portion thereof, under the influence of the surface tension at the end surface. Further, such a spin coating method is prone to be influenced by concave and convex shapes on the to-be-coated surface. This tends to degrade the thickness uniformity, in cases of fabricating an optical information recording medium having three or more information recording layers or forming a resin protective layer through a spin coating method, since the spin coating is applied to the previously-formed resin intermediate layers. Further, in the case of employing such a spin coating method, a time period of about 10 seconds is required for completing coating a single time, which may become a bottle-neck in increasing the production efficiency in fabrication of multi-layer information recording mediums.

On the other hand, in cases of forming resin intermediate layers through a screen printing method, it is possible to easily realize excellent thickness uniformity in comparison with spin coating methods. However, since the screen is brought into contact with the information recording layers and the information surface of the transfer substrate, the aforementioned case induces the problem that the information recording layers are directly or indirectly damaged. Furthermore, in such a screen printing method, a resin is supplied through only holes formed through the screen, so that there is the problem that air bubbles are prone to be introduced to portions which are not supplied with the resin.

It is an object of the present invention to overcome the problems of spin coating methods and screen printing methods to provide a multi-layer information recording medium which includes resin intermediate layers and/or a resin protective layer having uniform thicknesses controlled with high accuracy and also exhibits excellent signal characteristics.

An apparatus for fabricating a multi-layer information recording medium according to the present invention is an apparatus for fabricating a multi-layer information recording medium including a substrate, plural information recording layers placed on the aforementioned substrate, resin intermediate layers placed between adjacent information recording layers and a resin protective layer placed on all the information recording layers at the side opposite from the aforementioned substrate, the aforementioned apparatus including:

an ejecting unit including ink jet nozzles for dripping minute resin liquid drops onto the aforementioned substrate or the aforementioned information recording layers; and

a control unit for controlling the aforementioned ejecting unit;

whereby resin layers which form the aforementioned resin intermediate layers or the aforementioned resin protective layer are formed on the aforementioned substrate or the aforementioned information recording layers.

The apparatus for fabricating a multi-layer information recording medium according to the present invention employs an ink jet method capable of dripping minute resin liquid drops for applying resin for forming resin layers as resin intermediate layers or a resin protective layer, which can realize resin layers with thicknesses controlled with higher accuracy.

Further, the aforementioned ejecting unit is preferably moved between the inner circumferential side and the outer circumferential side of the aforementioned substrate.

Also, the aforementioned ejecting unit can include plural ink jet nozzles placed between the inner circumferential side and the outer circumferential side of the aforementioned substrate. The provision of plural ink jet nozzles instead of a single ink jet nozzle enables applying resin layers more rapidly.

The ejecting unit can be configured such that the density of ink jet nozzles near the outer circumferential side of the aforementioned substrate is greater than that near the inner circumferential side of the aforementioned substrate. Alternatively, the aforementioned ejecting unit can be configured such that the ink jet nozzles placed near the outer circumferential side of the aforementioned substrate eject greater amounts of resin than those placed near the inner circumferential side of the aforementioned substrate.

Further, the aforementioned ejecting unit has a greatest ejection width between the inner circumferential side and the outer circumferential side of the aforementioned substrate and the greatest ejection width can be equal to or greater than the radial width of the aforementioned information recording layers on the aforementioned substrate. It is possible to shorten the time period required for performing coating a single time with increasing greatest ejection width of the ejecting unit. Therefore, when the greatest ejection width of the ejecting unit is equal to or greater than the radial width of the information recording layers, namely the radius of the outermost circumference of the information surface minus the radius of the innermost circumference thereof, it is possible to complete coating a single time by rotating the information recording layers, namely the substrate, by only a single time, which can significantly shorten the coating time and therefore is preferable. Furthermore, when the greatest ejection width of the ejecting unit is equal to or greater than the desired to-be-coated surface of the information recording layers, namely the diameter of the outermost circumference of the information surface, it is possible to complete coating a single time by scanning the ejecting unit a single time, which can significantly shorten the coating time and therefore is particularly preferable.

Preferably, the ejecting unit includes ink jet nozzles capable of dripping minute resin liquid drops with a volume in the range of 1 pL to 1 nL. Further, each single ink jet nozzle is more preferably capable of ejecting minute resin liquid drops with a volume in the range of 5 to 100 pLs and is further more preferably capable of ejecting minute resin liquid drops with a volume in the range of 10 to 100 pLs.

Further, preferably, the apparatus for fabricating a multi-layer information recording medium further includes a rotating unit for rotating the substrate. In this case, the control unit controls the aforementioned rotating unit as well as the aforementioned ejecting unit. Further, preferably, the aforementioned control unit controls the rotation speed (with a unit of rpm) of the aforementioned substrate to equal to or less than five times the viscosity (with a unit of m-Pa) of the aforementioned resin.

Also, the aforementioned control unit can determine the amount of ejection from the aforementioned ejecting unit, according to the radius of the position on the aforementioned substrate onto which the aforementioned ejecting unit drips minute resin liquid drops.

A method for fabricating a multi-layer information recording medium according to the present invention is a method for fabricating a multi-layer information recording medium including a substrate, plural information recording layers placed on the aforementioned substrate, resin intermediate layers placed between adjacent information recording layers and a resin protective layer placed on all the information recording layers at the side opposite from the aforementioned substrate,

wherein minute resin liquid drops are dripped from an ejecting unit including ink jet nozzles onto the aforementioned substrate or the aforementioned information recording layers to apply the resin thereto to form resin layers which are the aforementioned resin intermediate layers or the aforementioned resin protective layer.

With the aforementioned fabricating method according to the present invention, it is possible to form resin layers with uniform thicknesses which do not depend on the radial position. Further, it is possible to smoothly fabricate an information recording medium including a greater number of information recording layers without contaminating the end surface of the information recording medium, which enables applying resin layers in a non-contact manner, thereby preventing the information surface from being damaged.

The step of applying the aforementioned resin can include moving at least one of said substrate and the aforementioned ejecting unit to spirally move the aforementioned ejecting unit over the aforementioned substrate relative to the aforementioned substrate.

Also, the step of applying the aforementioned resin can include determining the amount of ejection from the aforementioned ejecting unit, according to the radius of the position on the aforementioned substrate onto which the aforementioned ejecting unit drips minute resin liquid drops. The step of applying the aforementioned resin can include increasing the amount of ejection from said ejecting unit with increasing radius of the position on the aforementioned substrate onto which the aforementioned ejecting unit drips minute resin liquid drops. As described above, even when the information recording layers, namely the substrate is rotated at a lower rotation speed, it is possible to provide resin layers with thicknesses controlled with higher accuracy in the radial direction, by increasing the amount of ejection according to the radius of the position to which the resin is dripped.

Further, preferably, the step of applying the aforementioned resin includes controlling the rotation speed (with a unit of rpm) of said substrate to equal to or less than five times the viscosity (with a unit of m-Pa) of the aforementioned resin.

Also, the step of applying the aforementioned resin can include applying the aforementioned resin plural times. This enables forming resin layers with greater thicknesses which can not be formed by applying coating a single time and also enables applying plural types of resins.

Also, the step of applying the aforementioned resin can include embedding additional information members in the aforementioned resin layers, with at least one of the timings before, during and after applying the resin which mainly constitutes the aforementioned resin layers. In this case, it is possible to embed different additional information members in the respective resin layers, when there are plural resin layers.

A multi-layer information recording medium according to the present invention is a multi-layer information recording medium including a substrate, plural information recording layers placed on the aforementioned substrate, resin intermediate layers placed between adjacent information recording layers and a resin protective layer placed on all the information recording layers at the side opposite from the aforementioned substrate,

wherein the resin layers which are the aforementioned resin intermediate layers or the aforementioned resin protective layer are formed by dripping minute resin liquid drops from an ejecting unit including ink jet nozzles onto the aforementioned substrate or the aforementioned information recording layers for applying resin layers thereto.

With the fabricating apparatus and the fabricating method of a multi-layer information recording medium according to the present invention, it is possible to form resin intermediate layers and a resin protective layer with uniform thicknesses which do not depend on the radial position on a substrate. This enables smoothly fabricating an information recording medium including a greater number of information recording layers without contaminating the end surface of the information recording medium. Furthermore, the fabricating method and the fabricating apparatus according to the present invention employ an ink jet technique for applying resins in a non-contact manner, thereby preventing the information surface from being damaged. This can realize a multi-layer information recording medium which enables successfully recording and replaying signals therein and therefrom. Further, the fabricating method and the fabricating apparatus according to the present invention are capable of embedding additional information members having different additional information in individual respective information recording mediums, in addition to information originally provided in the information recording layers.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a schematic view illustrating the configuration of a fabricating apparatus of a multi-layer information recording medium according to a first embodiment of the present invention;

FIG. 2 is a flow chart of a fabricating method of a multi-layer information recording medium according to the first embodiment of the present invention;

FIG. 3 is a cross-sectional view illustrating an exemplary resin applying process, according to the first embodiment of the present invention;

FIGS. 4(A) and 4(B) are cross-sectional views illustrating two exemplary ink jet nozzles, according to the first embodiment of the present invention;

FIG. 5 is a cross-sectional view of a multi-layer information recording medium, according to the first embodiment of the present invention;

FIG. 6 is a view illustrating the rotation speed of a molded resin substrate, the resin viscosity and the thickness uniformity of a resin layer, according to the first embodiment of the present invention;

FIG. 7 is a view illustrating an exemplary ink jet head, according to the first embodiment of the present invention.

FIG. 8 is a cross-sectional view illustrating an exemplary resin applying process, according to the first embodiment of the present invention;

FIGS. 9(A) to (D) are cross-sectional views illustrating respective steps in processing for transferring an information surface to a resin layer, according to the first embodiment of the present invention;

FIG. 10 is a view illustrating the result of measurements of thicknesses of a resin layer fabricated through the multi-layer information recording medium fabricating method according to the first embodiment of the present invention;

FIG. 11 is a view illustrating the result of measurements of total thicknesses of three resin intermediate layers and a single resin protective layer in a four-layered information recording medium fabricated through the multi-layer information recording medium fabricating method according to the first embodiment of the present invention;

FIGS. 12(A) to (D) are views illustrating exemplary placements of additional information members, in the multi-layer information recording medium fabricating method according to the first embodiment of the present invention;

FIG. 13(A) is a view illustrating an exemplary process for applying a coating of a resin, according to a second embodiment of the present invention and FIG. 13(B) is a cross sectional view of FIG. 13(A);

FIGS. 14(A) to (D) are views illustrating an exemplary ink jet head, according to the second embodiment of the present invention;

FIGS. 15(A) and (B) are views illustrating the positional relationship between an ink jet head and a molded resin substrate, according to the second embodiment of the present invention;

FIG. 16 is a view illustrating an exemplary resin applying process, according to the second embodiment of the present invention;

FIG. 17 is a view illustrating the result of measurements of total thicknesses of three resin intermediate layers and a single resin protective layer in a four-layered information recording medium fabricated through the multi-layer information recording medium fabricating method according to the second embodiment of the present invention;

FIG. 18 is a cross-sectional view of a multi-layer information recording medium including information recording layers formed on the opposite surfaces of a molded resin substrate;

FIGS. 19(A) to (F) are cross-sectional views illustrating a fabricating method of a substrate fabricating die for fabricating a conventional multi-layer information recording medium;

FIG. 20 is a cross-sectional view of a conventional multi-layer information recording medium; and

FIGS. 21(A) to (I) are cross-sectional views illustrating respective steps in a fabricating method of a conventional multi-layer information recording medium.

### DESCRIPTION OF THE PREFERRED EMBODIMENTS

Hereinafter, embodiments of the present invention will be described with reference to the accompanying drawings. Although the present embodiments will be described with respect to exemplary configurations of information recording mediums having optical disk shapes, the present invention can be generally applied to multi-layer information recording mediums which are required to have excellent thickness accuracy, as well as information recording mediums for use for recording and replaying of information along with rotation thereof such as optical disks.

### First Embodiment

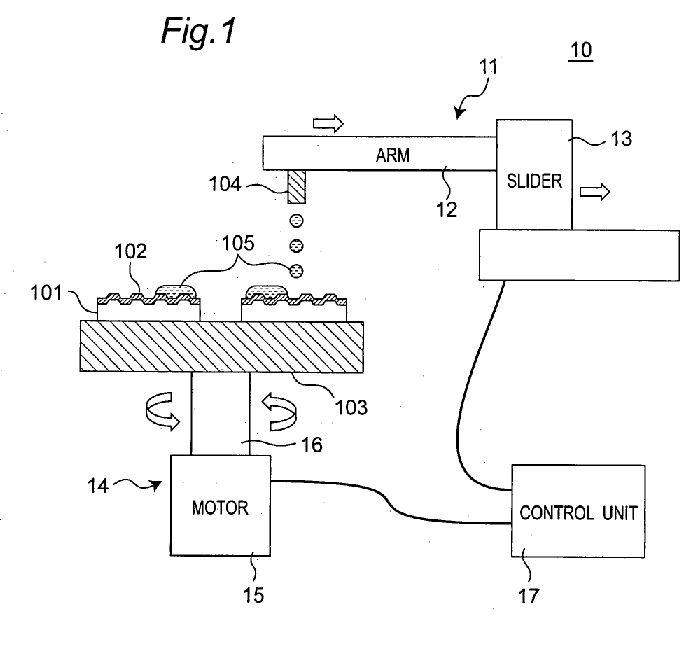

An apparatus 10 for fabricating multi-layer information recording mediums according to a first embodiment of the present invention includes an ejecting unit 11 including an ink jet head 104 having one or more ink jet nozzles for dripping small resin liquid drops 105 onto a substrate or an information recording layer on a substrate, a rotating unit 14 which rotates the substrate 101, and a control unit 17 which controls the ejecting unit 11 and the rotating unit 14, as illustrated in FIG. 1. The ejecting unit 11 includes an arm 12 provided with the ink jet head 104 and a slider 13 for moving the arm 12. Further, the rotating unit 14 includes a rotation table 103 which enables placing the substrate 101 thereon, a rotation shaft 16 which supports the rotation table 103 and defines the rotation center, and a motor 15 for rotating the rotation shaft 16. The control unit 17 controls the amount of ejection from the ink jet head 104 constituting the ejecting unit 11 and the movement of the arm 12 and also controls the rotation speed of the motor 15 in the rotating unit 14.

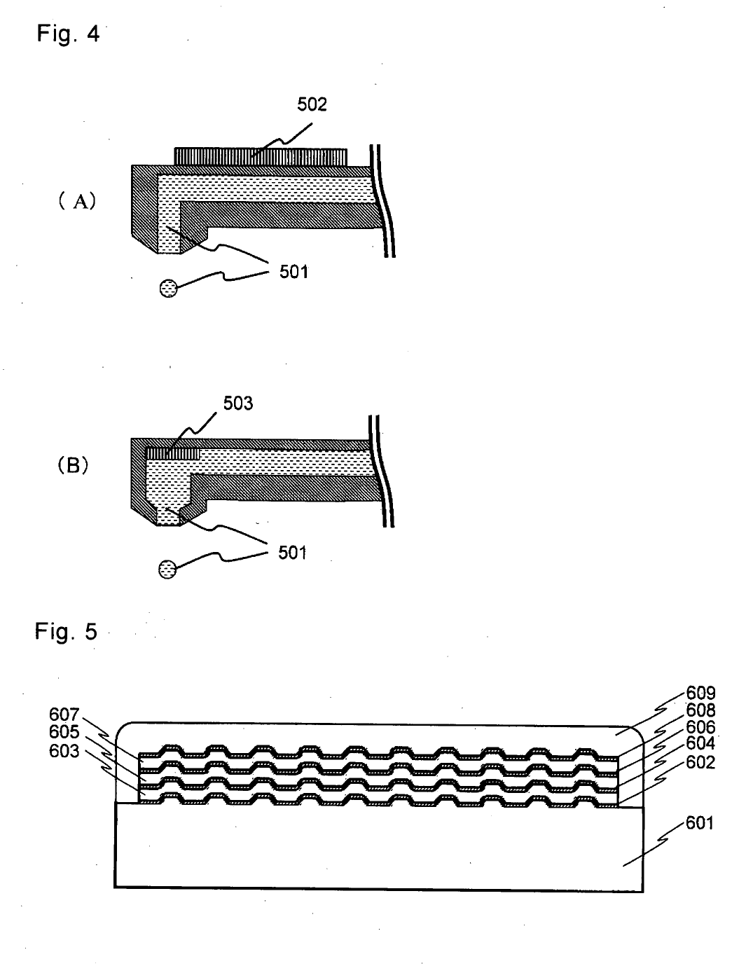

The ink jet head 104 constituting the ejecting unit 11 includes one or more ink jet nozzles for dripping minute resin liquid drops 105. The ink jet nozzles are nozzles which utilize an ink jet technique for ejecting minute liquid drops with volumes in the range of about 1 pL to 1 nL. FIGS. 4(A) and 4(B) are cross sectional views illustrating the configurations of two representative ink jet nozzles usable for implementing the present invention. In the figures, illustration of the supply channels, the liquid tank and the like for the to-be-ejected liquid 501 is omitted. FIG. 4(A) illustrates a nozzle of a type which extrudes to-be-ejected liquid 501 through a vibration device 502 such as a piezoelectric device for ejecting it and is called a piezo type ink jet nozzle. FIG. 4(B) illustrates a nozzle of a type which boils the to-be-ejected liquid using a heater 503 to utilize the volumetric expansion of the to-be-ejected liquid 501 near the heater as a power source for ejecting it and is called a thermal type (bubble jet (trademark) type). The present invention employs the ejecting unit 11 including the ink jet nozzle head 104 having a single ink jet nozzle or integrated plural ink jet nozzles as exemplified above for forming resin thin layers having thicknesses which are controlled with high accuracy. The ink jet nozzles usable for the present invention are not limited to those exemplified above. Further, it is necessary to cure the liquid ejected from the ejecting unit of the fabricating apparatus according to the present invention with light irradiation, after it is ejected therefrom. Accordingly, it is preferable to employ ink jet nozzles which cause no change in the quality of the to-be-ejected liquid during ejection, such as piezo type ink jet nozzles.

Next, the configuration of the ink jet head 104 which constitutes the ejecting unit 11 will be described in detail. The ink jet head 104 has at least one ink jet nozzle and is capable of properly ejecting minute resin liquid drops 105. Conventionally, in the field of ink jet technologies, in order to realize high accuracy printing and the like, there has been advanced development for reducing the sizes of liquid drops such as for reducing the volumes of minute liquid drops to about several pLs, for example. On the other hand, the multi-layer information recording medium fabricating apparatus according to the present invention is required to form resin layers with relatively large thicknesses in the range of, for example, about 10 to 20 μm. Accordingly, it is preferable to employ an ink jet head 104 capable of ejecting larger liquid drops with volumes of about several tens of pLs, as the ink jet head 104 of the ejecting unit 11. More specifically, it is possible to employ an ink jet head capable of ejecting minute liquid drops with volumes in the range of about 5 to 100 pLs, adaptable to resin viscosities in the range of about 5 to 40 m-Pa and operable at frequencies in the range of about 10 to 20 kHz.

Further, the ejecting unit 11 can move between the inner circumference side and the outer circumference side of the substrate 101. For example, as illustrated in FIG. 1, the arm 12 provided with the ink jet head 104 can be moved through the slider 13. Also, the arm 12 can be scanned within a two dimensional plane. This can eliminate the necessity of rotating the substrate itself. Also, the ink jet head 104 can include plural ink jet nozzles placed between the inner circumference side and the outer circumference side of the substrate, as will be describe later. Also, the ink jet head 104 can include ink jet nozzles placed in such a way that the density of ink jet nozzles placed near the outer circumference side of the substrate 101 is greater than that of ink jet nozzles placed near the inner circumference side of the substrate 101. Alternatively, the ink jet head 104 can include ink jet nozzles placed in such a way that the ink jet nozzles placed near the outer circumference side of the substrate 101 can eject greater amounts of resin than those placed near the inner circumference side of the substrate 101. Further, the ink jet head 104 can have a greatest ejection width between the inner circumference side and the outer circumference side of the substrate 101, and the greatest ejection width is equal to or greater than the radial width of the information recording layer on the substrate. Also, the ejecting unit can have a greatest ejection width which is equal to or greater than the size of the desired to-be-coated surface of the aforementioned information recording layer, namely equal to or greater than the diameter of the outermost circumference of the information surface.

The rotating unit 14 includes the rotation table 103 for securing the substrate 101 thereon, the rotation shaft 16 which supports the rotation table 103 and defines the rotation center, and the motor 15 for rotating the rotation shaft 16. The rotating unit 14 can rotate the substrate 101 about the rotation shaft 16. Also, for example, the substrate 101 can be secured on the rotation table 103 through vacuum suction.

The control unit 17 controls the ejecting unit 11 and the rotating unit 14. For example, the control unit 17 controls the amount of ejection from the ink jet head 104 and the movement of the arm 12. Further, the control unit 17 controls the rotation speed of the motor 15 in the rotating unit 14.

FIG. 5 is a cross sectional view of a multi-layer information recording medium which can be obtained by the fabricating apparatus according to the first embodiment of the present invention. The multi-layer information recording medium is constituted by a molded resin substrate 601 and plural information recording layers laminated thereon, wherein an information surface having concave and convex shaped pits and guide grooves has been formed, through transferring, on one side of the molded resin substrate 601. Hereinafter, description will be given by referring to the information surface side of the molded resin substrate 601 as an upper side while referring to the opposite side thereof as a lower side.

The multi-layer information recording medium includes a 0-th information recording layer 602, a first resin intermediate layer 603, a first information recording layer 604, a second resin intermediate layer 605, a second information recording layer 606, a third resin intermediate layer 607, a third information recording layer 608 and a resin protective layer 609 which are laminated in the mentioned order on the molded resin substrate 601. Each of the resin intermediate layers 603, 605 and 607 includes, on its upper surface, an information surface having concave and convex shaped pits and guide grooves which has been formed through transferring. In FIG. 5, the resin protective layer 609 has an outer diameter equal to the outer diameter of the molded resin substrate 601. However, it is necessary only that the resin protective layer substantially covers the uppermost information recording layer and, therefore, the outer diameter thereof can be greater or smaller than the molded resin substrate.

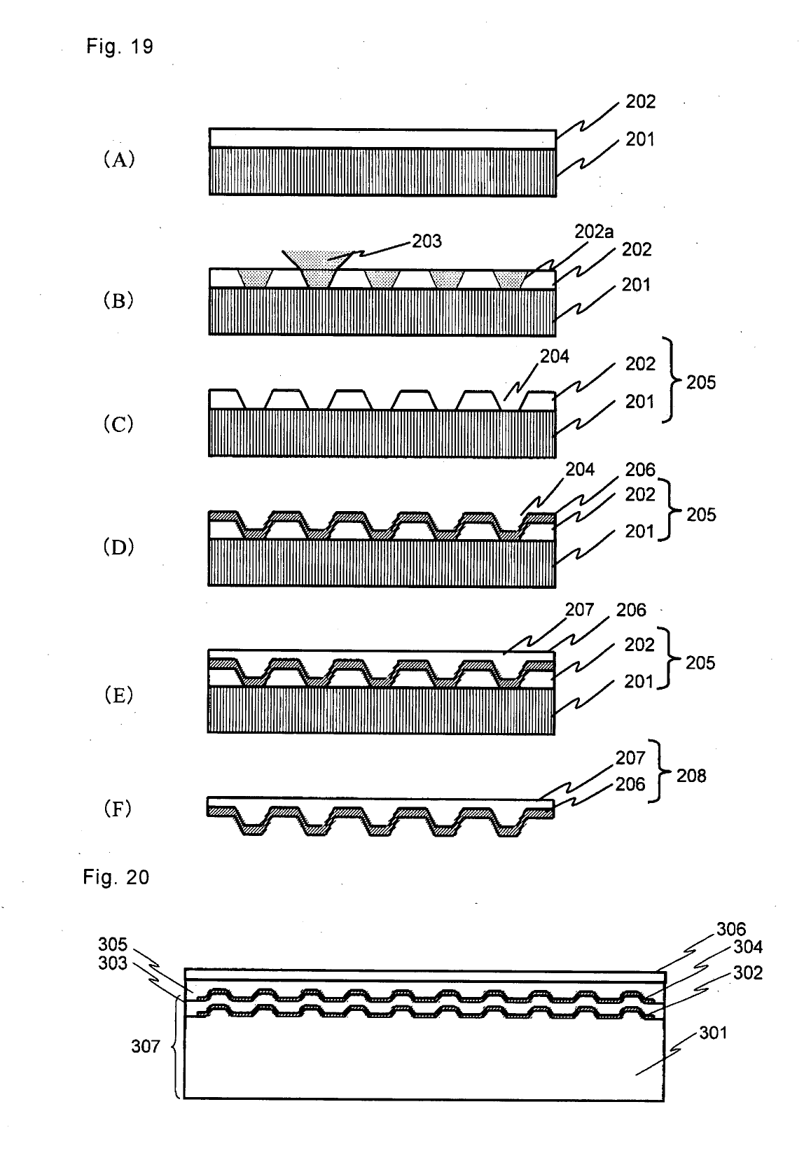

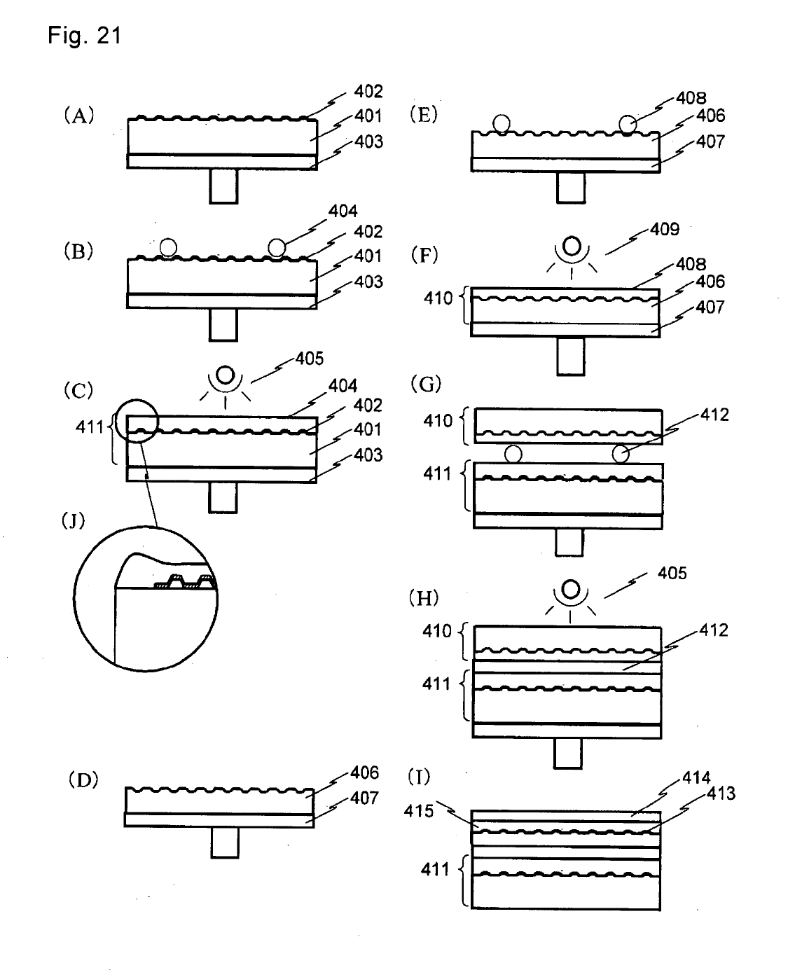

The molded resin substrate 601 is formed from a disk made of a polycarbonate or an acrylic resin with an outer diameter of 120 mm, a center hole diameter of 15 mm and a thickness in the range of about 1.0 to 1.1 mm, in order to allow its outer shape to have compatibility among optical disks such as CD disks, DVD disks, Blu-ray Discs. Further, an information surface having concave and convex shaped pits and guide grooves has been formed on its one surface, through resin molding such as injection molding using a conventional stamper as illustrated in FIG. 19(F). In the present embodiment, there will be described a case of using a polycarbonate, as a representative example.

In cases where the information recording medium is a read-only medium, the 0-th information recording layer 602 is required to have only at least a replay-light reflecting characteristic and, thus, is formed through a method for sputtering or vapor-depositing a reflective material containing, for example, Al, Ag, Au, Si, SiO₂, TiO₂ or the like. On the other hand, in cases where the information recording medium is a recordable medium, the 0-th information recording layer 602 includes at least a layer made of a phase change material such as GeSbTe or a recording material such as an organic dye such as phthalocyanine and also includes, as required, a layer for improving the recording/replaying characteristics such as a reflective layer and an interface layer since the 0-th information recording layer 602 is necessary to write information through irradiation of recording light. Further, the first information recording layer 604, the second information recording layer 606 and the third information recording layer 608 can be formed similarly to the aforementioned 0-th information recording layer 602.

The first resin intermediate layer 603 exhibits transparency to recording/replaying light and is made of, for example, an UV curable resin mainly constituted by an acrylic. A liquid UV curable resin is applied to the upper side of the 0-th information recording layer 602 using the ink jet head through a method which will be described later, then a transfer substrate having an information surface having pits, guide grooves and the like is pushed thereto and, at this state, an ultraviolet ray is applied thereto to cure the UV curable resin. Thereafter, the transfer substrate is removed from the interface with the UV curable resin to complete the formation of the first resin intermediate layer 603 made of the UV curable resin having concave and convex shapes transferred from the transfer substrate.

Further, the second resin intermediate layer 605 and the third resin intermediate layer 607 can be formed through a method similar to that for the aforementioned first resin intermediate layer 603.

The resin protective layer 609 exhibits transparency to recording/replaying light and can be formed by applying, for example, an UV curable resin mainly constituted by an acrylic through a spin coating method, an ink jet method, a screen printing method or the like and then curing it through irradiation of an ultraviolet ray. Also, a sheet-shaped material made of a polycarbonate or an acrylic can be attached through an adhesive agent or the like to form such a resin protective layer 609.

While there has been briefly described the general outline of the configuration and the fabrication method of a multi-layer information recording medium according to the embodiment of the present invention, the fabricating method of a multi-layer information recording medium according to the present invention is characterized by the method for forming resin intermediate layers or a resin protective layer, and the scope of the present invention is not limited by other configurations nor the fabricating method thereof.

Hereinafter, there will be described, in detail, the multi-layer information recording medium fabricating method according to the present invention, mainly with respect to the method for forming the resin intermediate layers, with reference to the accompanying drawings.

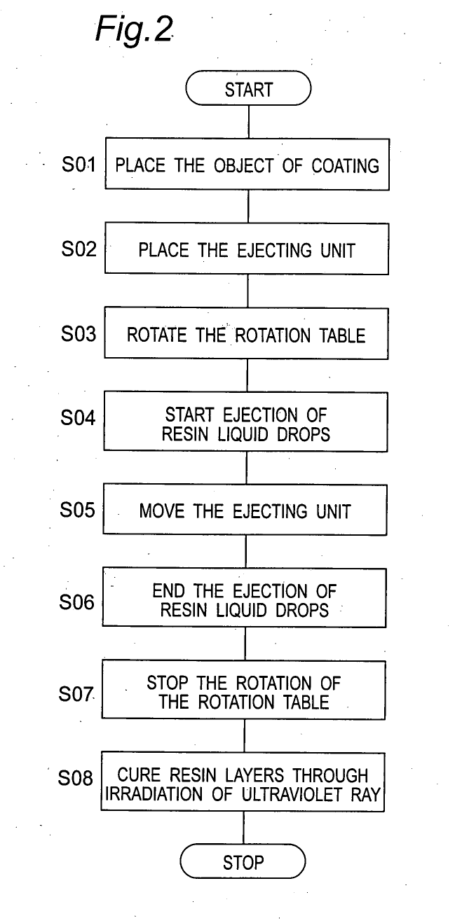

FIG. 2 is a flow chart of the fabricating method of a multi-layer information recording medium.

(a) A substrate 101 or a to-be-coated member including a substrate 101 and an information recording layer 102 thereon is placed (S01). In this case, the substrate 101 is placed on the rotation table 103 of the rotating unit 14. Further, it is preferable to make the center of the substrate 101 coincident with the rotation shaft 16.

(b) The ejecting unit 11 having the ink jet head 104 is placed (S02).

(c) The rotation table 103 is rotated (S03). The rotation table 103 is driven by the motor 15, wherein the driving condition such as the rotation speed and the like is controlled through the control unit 17.

(d) Ejection of resin liquid drops 105 from the ink jet head 104 is started (S04).

(e) The ink jet head 104 is moved (S05). For example, in the example of FIG. 1, the arm 12 provided with the ink jet head 104 is moved between the inner circumference side and the outer circumference side of the substrate 101 in the radial direction. Further, the method for moving the ejecting unit 11 is not limited to that in the example of FIG. 1. For example, the ejecting unit 11 can be scanned along paths defined within a two-dimensional plane.

(f) The ejection of resin liquid drops 105 from the ink jet head 104 is ended (S06). Consequently, the applying of the resin is ended.

(g) Thereafter, the rotation of the rotation table 103 is stopped (S07).

(h) An ultraviolet ray is applied to the resin layer to cure them (S08). Further, in the case where the resin layer is a resin intermediate layer, the processing for forming a concave-and-convex shaped information surface having pits and guide grooves is performed as will be described later, prior to the irradiation of the ultraviolet ray. On the other hand, in the case where the resin layer is a resin protective layer, an ultraviolet ray is applied thereto to cure the resin after the resin is applied.

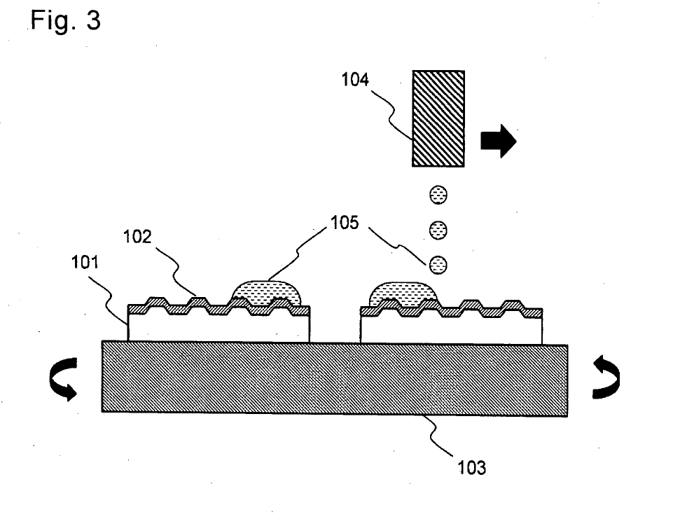

FIG. 3 is a cross sectional view illustrating exemplary processing for applying a resin layer which is a resin intermediate layer or a resin protective layer in the multi-layer information recording medium fabricating method according to the first embodiment of the present invention. First, on the surface of the molded resin substrate 101 on which an information surface having pits and guide grooves has been formed, there has been formed a 0-th information recording layer 102 including at least one of a recording film material and a reflective film material, through sputtering, vapor deposition or other methods. Further, the molded resin substrate 101 is secured at its surface opposite from the surface on which the 0-th information recording layer 102 has been formed, on the rotation table 103 which is the rotation unit, through vacuum suction or other means.

Above the molded resin substrate 101, there is placed the ink jet head 104 having one or more ink jet nozzles, so that minute resin liquid drops 105 of an UV curable resin are successively dripped from the ink jet head 104 while the molded resin substrate 101 is rotated together with the rotation table 103. The volume of resin dripped at a time is in the range of about 1 pL to 1 nL and thus is extremely small. At this time, one or both of the ink jet head 104 and the rotation table 103 are moved, so that the position at which the UV curable resin is dripped is relatively moved at least in the radial direction of the molded resin substrate 101. Accordingly, the UV curable resin is dripped in a spiral manner and, finally, a layer made of the UV curable resin is formed to cover the 0-th information recording layer 102. Further, in view of ease of control, it is preferable to move the ink jet head 104 horizontally in the radial direction of the molded resin substrate 101, as a preferable moving method according to the present invention.

Hereinafter, there will be described a calculating formula regarding the scanning speed and the coating time required for forming a resin intermediate layer through the fabricating method according to the present invention. The resin intermediate layer is formed to have a torus-shape, and the coating time t can be determined from the following formula (1), wherein the inner diameter (radius) of the torus-shape is r₁, the outer diameter (radius) thereof is r₂, the area of the resin intermediate layer is S, the thickness of the resin intermediate layer is d, the volume of minute liquid drops 105 ejected from the ink jet head 104 is v and the operation frequency of the ink jet head 104 is f.

$$\begin{matrix}[ Formula 1 ] & \\ t = \frac{S \times d}{f \times v} = \frac{π ( {γ}_{2}^{2} - {γ}_{1}^{2} ) \times d}{f \times v} & ( 1 )\end{matrix}$$

Further, assuming that the feeding pitch is x in the case of spiral coating, the relative scanning speed (linear speed) of the ink jet head is expressed as f×x. Further, the area which is coated per unit time is expressed as the following formula (2). Accordingly, x can be determined from the following formula (3).

$$\begin{matrix}[ Formula 2 ] & \\ x \times f \times x = \frac{S}{t} = \frac{S \times f \times v}{S \times d} = \frac{f \times v}{d} & ( 2 ) \\ [ Formula 3 ] & \\ x = \sqrt{\frac{v}{d}} & ( 3 )\end{matrix}$$

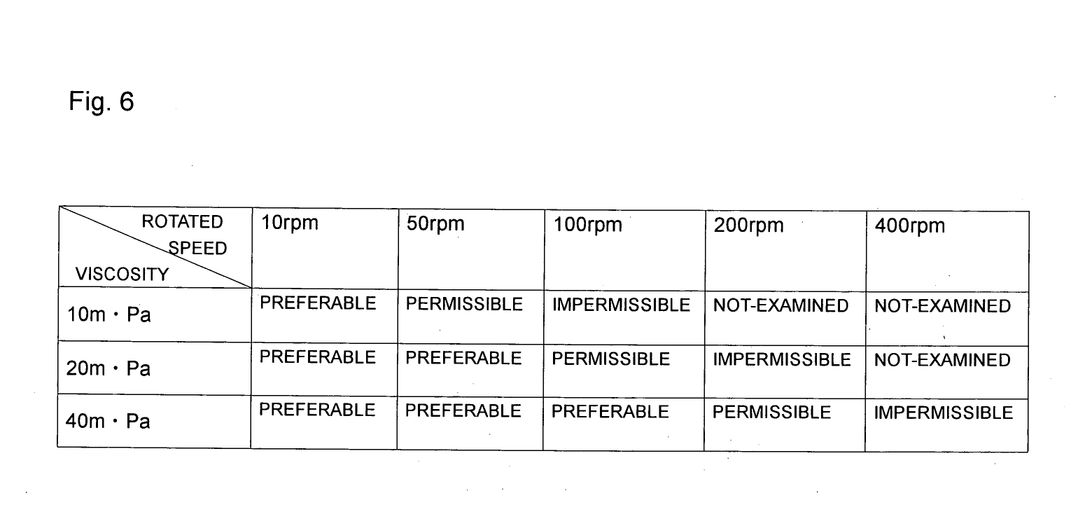

For example, in the case of forming a resin layer having an inner circumference with a radius of 15 mm, an outer circumference with a radius of 59 mm and a thickness of 20 μm using an ink jet head 104 having a single ink jet nozzle capable of ejecting minute liquid drops 105 each having a volume of 20 pLs and operable at a frequency of 10 kHz, the coating time is about 1000 seconds, the feeding pitch of the ink jet head is about 30 μm and the scanning speed is about 0.3 m/s. In this case, it is assumed that the coating is performed at a constant scanning speed and, therefore, the rotation speed of the molded resin substrate 101 is varied according to a constant linear velocity (CLV) manner and, thus, the rotation speed is varied depending on the scanning radius. In the case where the scanning speed is 0.3 m/s, the rotation speed of the molded resin substrate 101 during applying coating to the inner circumferential portion thereof is about 190 rpm. However, if the rotation speed is relatively larger, this will induce the problem of variation of the distribution of the thickness of the resin layer due to centrifugal force. The upper limit of permissible rotation speeds significantly depends on the viscosity of the used UV curable resin, as illustrated in FIG. 6. FIG. 6 illustrates a case where resin intermediate layers with an average thickness of 20 μm are formed using UV curable resins with viscosities of 10, 20 and 40 m-Pa while the rotation speed of the molded resin substrate is varied, wherein thickness variations of 1 micrometer or less are defined as “preferable”, thickness variations of 2 μm or less are defined as “permissible” and thickness variations greater than 2 μm are defined as “impermissible”. For example, in the case where the resin viscosity is about 20 m-Pa, it is preferable that the rotation speed is 100 rpm or less. Assuming that the rotation speed of the to-be-coated member is R (rpm) and the viscosity of the UV curable resin is p (m-Pa), it can be seen from FIG. 6 that the method according to the present invention can be successfully performed by using a combination of a rotation speed and a viscosity which satisfy the following formula (4).

R≦5p (4)

If the scanning speed is set to about 0.15 m/s, the rotation speed at the innermost circumference is about 100 rpm and is decreased with decreasing distance to the outer circumference in proportion to the radius and, therefore, the coating can be successfully performed in the case where the used resin has a viscosity of 20 m-Pa. In this case, the coating time is about 2000 seconds. Further, it is preferable to employ an UV curable resin having a higher viscosity in the present invention, in view of increasing the rotation speed of the molded resin substrate, and it is possible to sufficiently preferably employ an UV curable resin having a viscosity of 10 m-Pa or more. Further, it is possible to easily reduce the coating time, through means which will be described later.

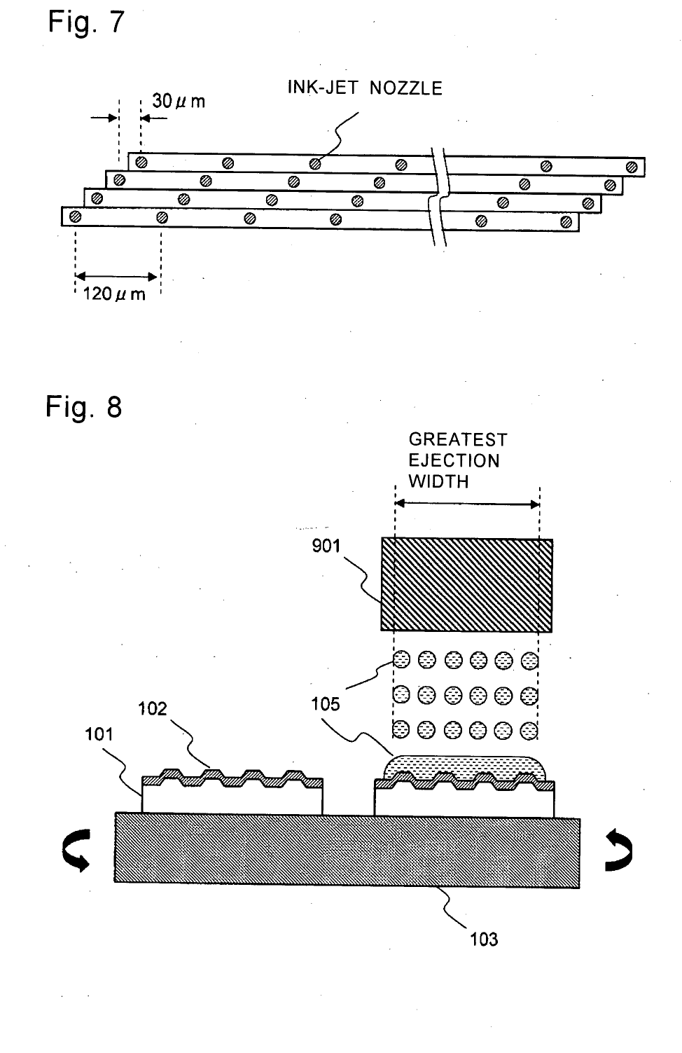

Next, the reduction of the coating time will be further studied. A coating time of 2000 seconds is excessively long in actually fabricating an information recording medium, but the coating time can be easily reduced by increasing the number of ink jet nozzles included in the ink jet head 104. It is possible to place the ink jet nozzles in such a manner that they are arranged in a tangential direction or a radial direction of the molded resin substrate or in such a manner as to combine the aforementioned two cases. In the case where they are arranged in a tangential direction, it is necessary to take account of impossibility of increasing of the rotation speed, since there is a need for an idea for increasing the scanning speed. Namely, it is preferable to arrange the ink jet nozzles in a radial direction of the molded resin substrate and, for example, if 200 nozzles are arranged, then the coating time becomes about 10 seconds, which is a sufficiently practical time. In this case, the intervals at which the nozzles are placed should be set to the feeding pitch x as previously determined, but if it is difficult to place the nozzles at such intervals, then plural nozzle rows can be provided. For example, as illustrated in FIG. 7, it is possible to arrange four nozzle rows each including 50 nozzles arranged at 120-μm intervals such that the nozzle rows are displaced with respect to one another by 30 μm to constitute an ink jet head substantially equivalent to an ink jet head including 200 nozzles arranged at 30-micrometer intervals.

While, in the aforementioned example, there has been described a case where both the amount of ejection from the ink jet head and the scanning speed thereof are constant during applying coating and the rotation speed of the molded resin substrate 101 depends on the coating radius, there may be possibly cases where the overall control can be made easier by making the rotation speed of the molded resin substrate 101 constant. In such a case, it is preferable to change the amount of ejection from the ink jet head constituting the ejecting unit 11 in proportion to the radius. In order to change the amount of ejection, it is possible to employ a method for changing the amount of liquid drops dripped from each single ink jet nozzle or a method for changing the number of operable ink jet nozzles, and both the methods will not limit the effects of the present invention. Further, as illustrated in FIG. 8, by using an ink jet nozzle 901 having a largest ejection width equal to or greater than the radial width in which resin intermediate layers and a resin protective layer are required to be formed, the amount of ejection from the ink jet head 901 can be made proportional to the radius, which enables completing coating only through a single rotation of the molded resin substrate 101 without requiring parallel movement of the ink jet head 901. In this case, in cases where the rotation speed is 60 rpm, for example, it is possible to significantly shorten the coating time to 1 second. As a matter of course, in this case, it is possible to rotate either only the ink jet head 901 or both the molded resin substrate 101 and the ink jet head 901.

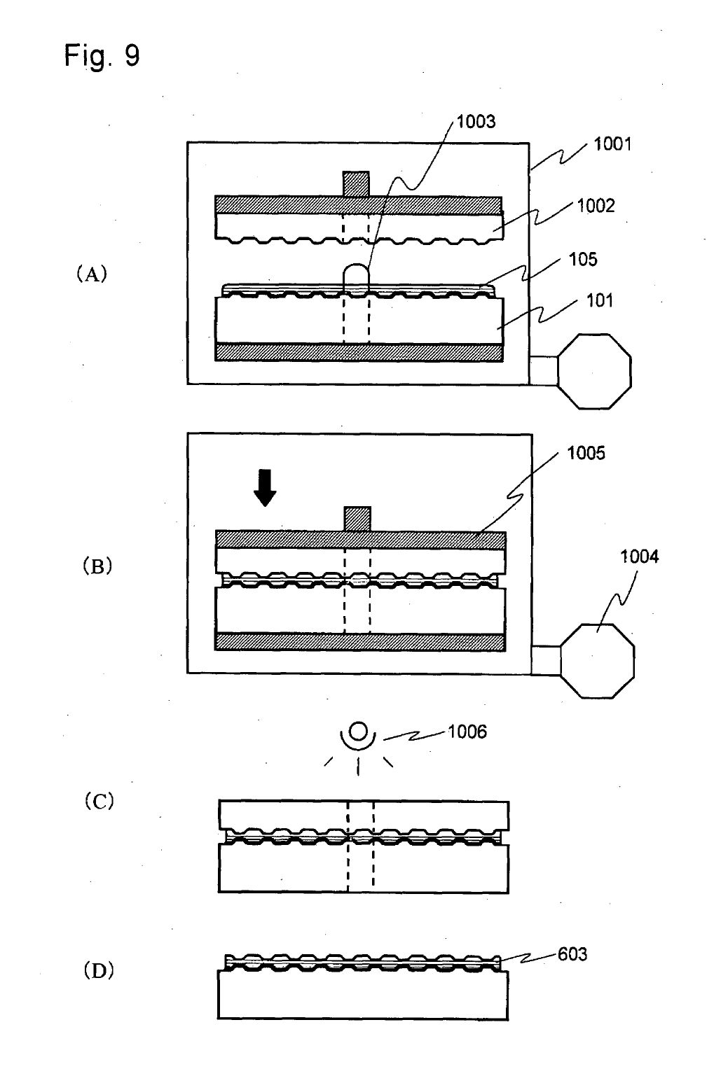

FIGS. 9(A) to (D) are cross sectional views illustrating exemplary processing for performing transferring to a resin intermediate layer, according to the present embodiment of the present invention. The molded resin substrate 101 which has been coated with the UV curable resin 105 is then transferred to the inside of a vacuum chamber 1001. At this time, a transfer substrate 1002 has been also placed within the vacuum chamber 1001. The transfer substrate 1002 is made of a polyolefin material which can be preferably exfoliated from the UV curable resin 105 and is formed to have a thickness smaller than that of the molded resin substrate 101, such as a thickness of 0.6 mm, for example. This is for enabling exfoliating the signal transfer substrate 1002 from the molded resin substrate 101 having a thickness of 1.1 mm, by warping the transfer substrate utilizing the rigidity difference between the substrates due to the thickness difference therebetween.

Such a polyolefin material enables easily forming, on its one surface, an information surface having concave and convex shaped pits, guide grooves and the like through injection molding or other methods using a conventional stamper, similarly to the molded resin substrate 101. Further, such a polyolefin material exhibits higher transparency to ultraviolet rays, which enables irradiation of an ultraviolet ray through the transfer substrate 1002 to efficiently cure the UV curable resin. Furthermore, it is characterized in that such a polyolefin material exhibits low adhesion to the cured UV curable resin, which enables easily exfoliating it from the interface with the cured UV curable resin. The substrate is provided, at its center portion, with a center hole for defining the eccentricity through a center boss 1003 with respect to the molded resin substrate 101 (see FIG. 9(A)). Evacuation is performed within the vacuum chamber 1001 through a vacuum pump 1004 such as a rotary pump or a mechanical booster pump, for example, which enables creating a vacuum atmosphere within a shorter time. In the present embodiment, when the degree of vacuum within the vacuum chamber 1001 reaches 100 Pa or less, the transfer substrate 1002 is overlaid onto the molded resin substrate 101. At this time, the transfer substrate 1002 is pressed by a pressing plate 1005 placed on the transfer substrate 1002, so that the information surface formed on the transfer substrate 1002 is transferred to the UV curable resin 105.

The vacuum atmosphere within the vacuum chamber 1001 enables attaching the UV curable resin 105 and the transfer substrate 1002 to each other without involving intrusion of air bubbles therebetween (see FIG. 9(B)). An ultraviolet ray is applied to the molded resin substrate 101 and the transfer substrate 1002 attached to each other, within the vacuum chamber 1001 or after they are drawn therefrom, by an ultraviolet-ray irradiation apparatus 1006 through the transfer substrate 1002 (see FIG. 9(C)). Thereafter, the transfer substrate 1002 is exfoliated from the interface between the UV curable resin 105 and the transfer substrate 1002 by driving a wedge between the transfer substrate 1002 and the UV curable resin 105 or by blowing compression air therebetween. Thus, the formation of the first resin intermediate layer 603 having an information surface formed through transferring is completed (see FIG. 9(D)).

It is also possible to employ various types of known methods for transferring an information surface to a UV curable resin layer, other than the method described above, such as, for example, a method which employs a transfer substrate made of a different material such as a metal, a method which employs two or more types of UV curable resins for forming a resin intermediate layer made of two or more resin layers, or a method which applies an ultraviolet ray to UV curable resin layers from the molded resin substrate side thereof. Any of these methods can offer the effect of forming a UV curable resin with a uniform thickness according to the method of the present invention. For example, a UV curable resin which exhibits higher adhesion to an information recording layer can be placed on the information recording layer and, then, a UV curable resin which exhibits lower adhesion to the transfer substrate can be placed thereon to enable easily exfoliating the transfer substrate therefrom after the transferring of an information surface. In this case, the respective UV curable resins can be formed by performing, twice, the coating method according to the present invention. In order to perform the coating twice, the first coating can be applied to the entire desired to-be-coated area and, after the completion of the first coating, the second coating can be started. Alternatively, the second coating can be started, before the first coating to the entire desired to-be-coated area is completed. The UV curable resin formed through the first coating can be cured either after the completion of the second coating or before the second coating. Further, in the case where the first coating is overlapped with the second coating in terms of time, a ultraviolet-ray irradiation mechanism capable of irradiation can be used only for the area which has been subjected to the first coating. For example, an ultraviolet lamp capable of partial irradiation can be installed in the ink jet head.

Further, while there has been exemplified a method for applying coating twice for forming a resin intermediate layer using two types of UV curable resins, the method according to the present invention can be utilized for applying coating plural times to offer the effects, regardless of the type and the number of resins, for example, in cases where three or more types of UV curable resins are employed or in cases where it is impossible to apply a coating with a desired thickness by applying coating a single time due to shortage of the capacity of the ink jet nozzles.

Further, the method according to the present invention utilizes an ink jet technique capable of easily performing position control with high accuracy for applying coatings of resins which form resin intermediate layers, thereby improving the positional accuracy of the coating area, as well as the accuracy of the coating thickness, in comparison with conventional spin coating methods, screen printing methods and the like. For example, there will be exemplified a case where there is a need for an information recording medium which has an outer circumference having a radius of 60 mm and includes information recording layers having an outer circumference side having a radius of 58.5 mm. Conventional methods such as spin coating methods may cause resins to protrude from the outer circumferential end surface of the information recording medium, in cases of applying a resin coating to cover the entire information recording layers, which may degrade the appearance of the information recording medium and also may make it impossible to preferably laminate information recording layers and a resin intermediate layer thereafter. However, the ink jet technique for use in the method according to the present invention enables easily applying coating with positional accuracy involving errors of 0.1 mm or less, which enables applying coatings of resins which form resin intermediate layers or a resin protective layer, in such a manner that the resins completely cover the under information recording layers without protruding from the outer circumferential end surface of the information recording medium. This can improve the appearance of information recording mediums and increase the fabrication yield thereof.

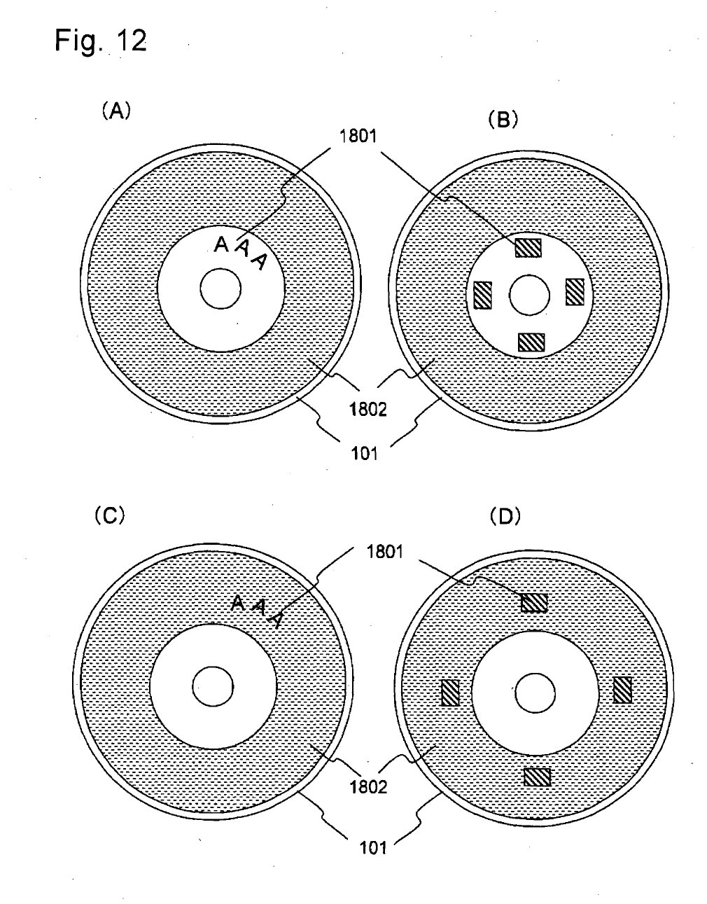

Further, there will be described a case of providing additional information members 1801 having additional information which can be read from the outside, in resin intermediate layers or a resin protective layer in a multi-layer information recording medium. As illustrated in FIGS. 12(A) to (D), it is possible to apply, to certain areas, a coating of a material different from the material which mainly form the resin intermediate layers, for example, such as a liquid containing a dye, an inorganic material or the like, to fabricate the information recording layers and then embed additional recording members 1801 which enable reading information therefrom through light or an electromagnetic field from the outside, independently of the information recording layers. Further, it is possible to easily form such additional information members 1801 having different shapes in respective multi-layer information recording mediums and in the respective information recording layers therein through the control of the ink jet nozzles, which enables utilizing the additional information members 1801 for authentication of individual multi-layer information recording mediums or the individual information recording layers therein. For example, it is possible to apply, to certain areas, a coating of a material which has optical characteristics different from those of the material mainly constituting the resin intermediate layers to embed, therein, shape information such as characters or barcodes (FIGS. 12(A) and 12(C)) to be read through laser light for replaying the information recording layers. Also, it is possible to apply, to certain areas, a coating of a conductive material or a semiconductor material to embed, therein, circuit-shaped information (FIGS. 12(B) and 12(D)) which is responsive to a certain electromagnetic field, such as that used as radio frequency identification tags, to be read through such an electromagnetic field. In cases where such additional information members 1801 exert only permissible adverse influences on reading and writing of information from and to the original information recording layers, the additional information members 1801 can be placed at positions overlapped with the information area 1802 of the information recording layers (FIGS. 12(A) and 12(B)). On the other hand, if such additional information members 1801 exert impermissible adverse influences thereon, they must be positioned in such a manner as to prevent them from being overlapped with the information area 1802 of the information recording layers.

Next, the formation of the resin protective layer 609 will be described. Returning to FIG. 5, after the formation of the first resin intermediate layer 603, plural information recording layers and a resin protective layer are laminated according the same method as those for the 0-th information recording layer 602 and the first resin intermediate layer 603 to alternately laminate four information recording layers and three resin intermediate layers on the molded resin substrate 601. The resin protective layer 609 is formed as an outermost layer.

The resin protective layer 609 exhibits transparency to recording/replaying light and is formed, for example, by applying a coating of an UV curable resin mainly constituted by an acrylic through a spin coating method, an ink jet method, a screen printing method or the like and then curing it through irradiation of an ultraviolet ray. Also, a sheet-shaped material made of a polycarbonate or an acrylic can be attached through an adhesive agent to form such a resin protective layer 609. Further, the aforementioned respective methods are well-known techniques and, therefore, detailed description thereof is omitted herein.

On the other hand, the resin protective layer 609 can be formed through an ink jet method, in the fabricating method of a multi-layer information recording medium according to the present invention. Here, a method for forming a resin protective layer through an ink jet method will be described in detail.

In order to form the resin protective layer 609 through an ink jet method, an UV curable resin can be applied through the same method as that previously described with respect to the formation of the resin intermediate layer with a thickness of 20 μm and, then, an ultraviolet ray can be applied thereto to cure it without performing processing for transferring an information surface. Also, it is possible to overlay a flat plate having a flat surface having no concave and convex shapes such as an information surface on a UV curable resin such that the flat surface having no concave and convex shapes such as an information surface is in contact with the UV curable resin, in the same way as that for overlaying the transfer substrate during the formation of the resin intermediate layers, then apply an ultraviolet ray thereto to cure it and then exfoliate the flat plate therefrom, which can improve the uniformity of the thickness of the resin protective layer and the flatness of the surface of the resin protective layer. In order to form a resin protective layer with a thickness of 40 μm, it is possible to employ minute liquid drops with a volume twice that for forming a resin intermediate layer with a thickness of 20 μm, but it is also possible to form a resin protective layer plural times, for example, in such a way as to form a resin protective layer with a thickness of 20 μm, then form a resin protective layer with a thickness of 20 μm again and then cure them through an ultraviolet ray, in cases where there is the problem of shortage of the capacity of the ink jet nozzles. In this case, it is also possible to cure, through an ultraviolet ray, only the resin protective layer formed through the first coating, after the first coating but before the second coating. The use of the method can make it easier to form, using the same ink jet nozzles, resin intermediate layers with a smaller thickness and a resin protective layer with a greater thickness.

Further, there is no need for transferring concave and convex shapes such as an information surface during the formation of the resin protective layer and, therefore, it is possible to apply a coating of a resin for forming a resin protective layer while successively applying an ultraviolet ray only to the area which has been coated with the resin, for curing it, for example, in such a way as to provide an ultraviolet-ray irradiation mechanism in the ink jet head and move and position the ultraviolet-ray irradiation mechanism following the ink jet head.

Next, the thicknesses of the resin protective layer 609 and the resin intermediate layers will be described. The thicknesses of the resin protective layer 609 and the resin intermediate layers are determined, in view of technical backgrounds as follows. In an optical information recording medium including plural information recording layers, there are different distances from the surface of the information recording medium (the surface of the resin protective layer) to the individual respective information recording layers, when viewed from the replay-surface side. Namely, in order to realize preferable recording/replaying characteristics, it is necessary to apply different aberration corrections to the individual respective information recording layers. In order to reduce the difference among the different amounts of aberration corrections required for the respective information recording layers for making it easier to fabricate recording/replaying apparatuses, it is preferable to decrease the thicknesses of the resin intermediate layers as much as possible. However, with decreasing thicknesses of the resin intermediate layers, the amount of reflected light which is intruded as stray light into replay light, out of the reflected light from information recording layers adjacent to a to-be-replayed information recording layer, is increased, which degrades the quality of replaying. From the aforementioned viewpoints, it is preferable to set the thicknesses of the resin intermediate layers to in the range of about 10 to 30 μm, in a multi-layer information recording medium which is replayed using a pickup head being applicable to replay-light wavelengths of about 400 nm and including an objection lens having a numerical aperture of about 0.85.

Assuming that there is a distance of 100 μm from the surface of the information recording medium (the surface of the resin protective layer) to the information recording layer placed at a deepest position when viewed from the replay-surface side, the thickness of the resin protective layer 609 in a multi-layer information recording medium having four information recording layers according to the present embodiment is automatically determined by determining the thicknesses of the resin intermediate layers. For example, when the thickness of all the resin intermediate layers is set to 20 μm, the thickness of the resin protective layer 609 is determined to be 40 μm. As a matter of course, it is not necessary that the respective resin intermediate layers have the same thickness, and it may be possible to reduce stray light from other information recording layers than an in formation recording layer to be replayed by making their thicknesses different from one another. In any of the cases, it is possible to offer the effects of the present invention.

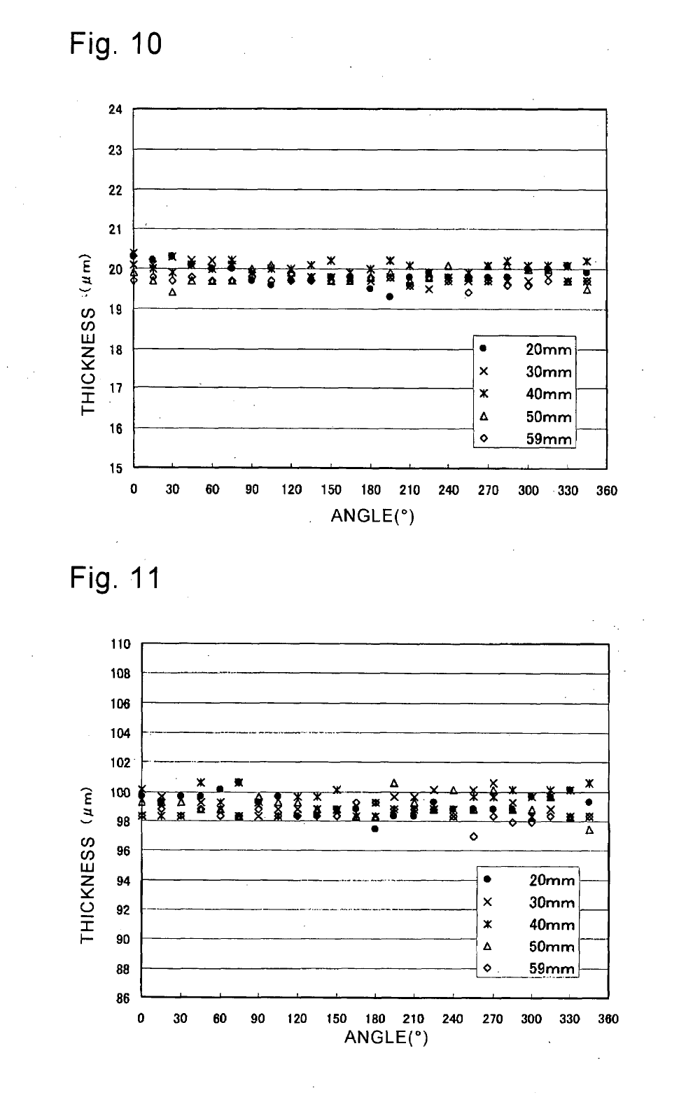

FIG. 10 is a view illustrating the result of thickness measurements at respective points within the surface of a resin intermediate layer with a thickness of 20 μm which was formed through the fabricating method according to the present invention. FIG. 10 shows that the use of the fabricating method according to the present invention could sufficiently reduce the thickness variation within the surface of the resin intermediate layer to equal to or less than 2 μm. Further, FIG. 11 illustrates the result of measurements of the thicknesses at respective points within the surface of a four-layered information recording medium fabricated through the fabricating method according to the present invention, wherein the four-layered information recording medium includes four information recording layers, three resin intermediate layers with a thickness of 20 μm provided between the respective information recording layers and a single outermost resin protective layer with a thickness of 40 μm and the aforementioned thicknesses are the thicknesses from the surface of the information recording medium (the surface of the resin protective layer) to the information recording layer placed at the deepest position, at the respective points, when viewed from the replay-surface side thereof. FIG. 11 shows that the use of the fabricating method according to the present invention could sufficiently reduce the variation of the thickness from the surface of the information recording medium (the surface of the resin protective layer) to the information recording layer placed at the deepest position from the replay-surface side to equal to or less than 6 μm, in the case of fabricating the multi-layer information recording medium including the four information recording layers.

As described above, the multi-layer information recording medium fabricating method according to the present invention can fabricate a multi-layer information recording medium having resin intermediate layers and a resin protective layer having thicknesses controlled with higher accuracy. Particularly, the fabricating method according to the present invention is not influenced by concave and convex shapes on the to-be-coated resin surface as spin coating methods, which can ensure excellent thickness accuracy even in cases of forming many information recording layers. Furthermore, the fabricating method according to the present invention does not require contacting with the to-be-coated surface (the information recording layers) as screen printing methods, which can prevent the to-be-coated surface from being damaged, thereby offering the advantageous effect of applying the resins forming the resin intermediate layers and the resin protective layer, in such a manner as not to contact with the to-be-coated surface. The fabricating method according to the present invention is capable of controlling the area coated with the resins which form the resin intermediate layers, in such a way that the coated area completely covers the required area of the information recording layers while being prevented from protruding from the outer circumferential end surface of the molded resin substrate, thereby improving the appearance of the information recording medium, since the fabricating method according to the present invention utilizes an ink jet technique for which excellent position control techniques have been established.

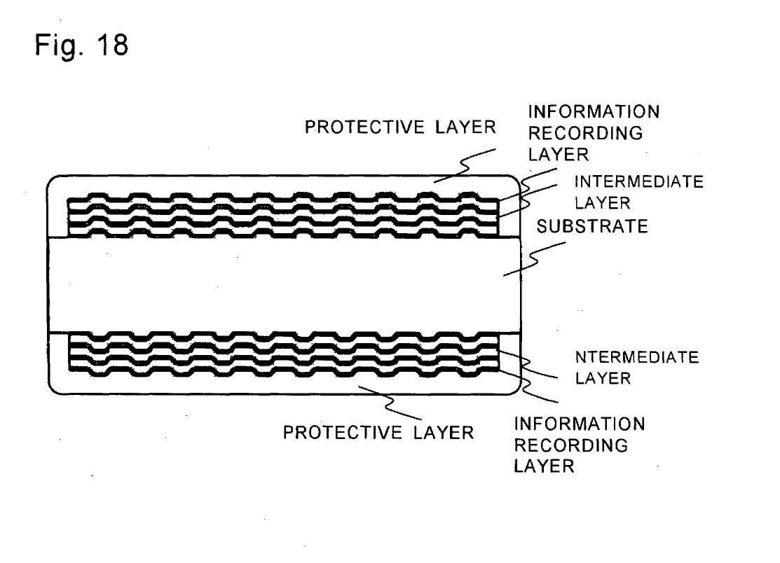

Further, while, in the first embodiment, there has been described a case where an information surface has been transferred to the molded resin substrate in advance, even if the molded resin substrate is a simple flat place having no information surface, this will not limit the effects of the fabricating method according to the present invention, while merely reducing the number of information recording layers by one. Further, while, in the first embodiment, there has been exemplified a case where information recording layers and a resin protective layer are formed on a single side of a molded resin substrate, the fabricating method according to the present invention can be utilized for forming information recording layers and a resin protective layer on the both sides of a molded resin substrate as illustrated in FIG. 18. In this case, an information surface can be formed on each of the sides of the molded resin substrate during the molding thereof. Also, it is possible to attach two molded resin substrates each having an information surface formed on its one side to each other, at their sides having no information surface. Further, the method according to the present invention can be used in cases where no information surface is not formed on one or both of the molded resin substrates.

### Second Embodiment

There will be described a fabricating method of a multi-layer information recording medium according to a second embodiment of the present invention. The second embodiment is different from the first embodiment in the method for applying UV curable resins for forming resin intermediate layers or a resin protective layer. However, the other processes such as the method for forming the molded resin substrate and the method for transferring an information surface are the same as those in the first embodiment. Therefore, there will be described the method for applying UV curable resins which is the characteristic of the second embodiment, while description of the other processes required for fabricating the multi-layer information recording medium according to the present invention will be omitted.

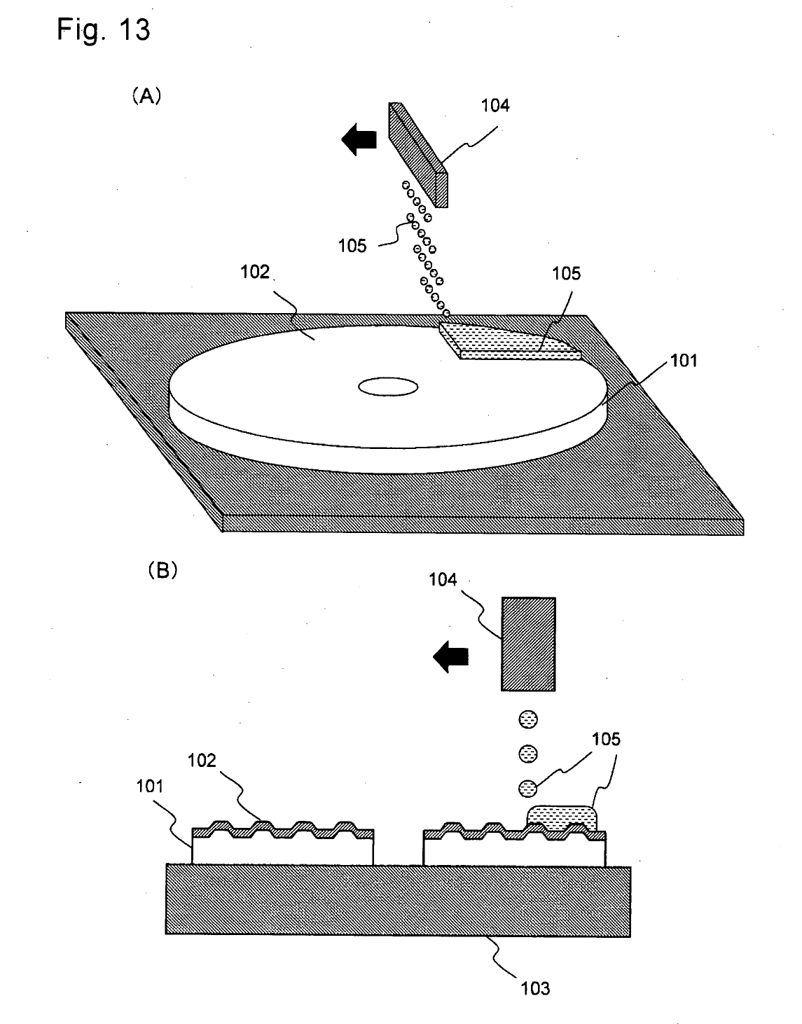

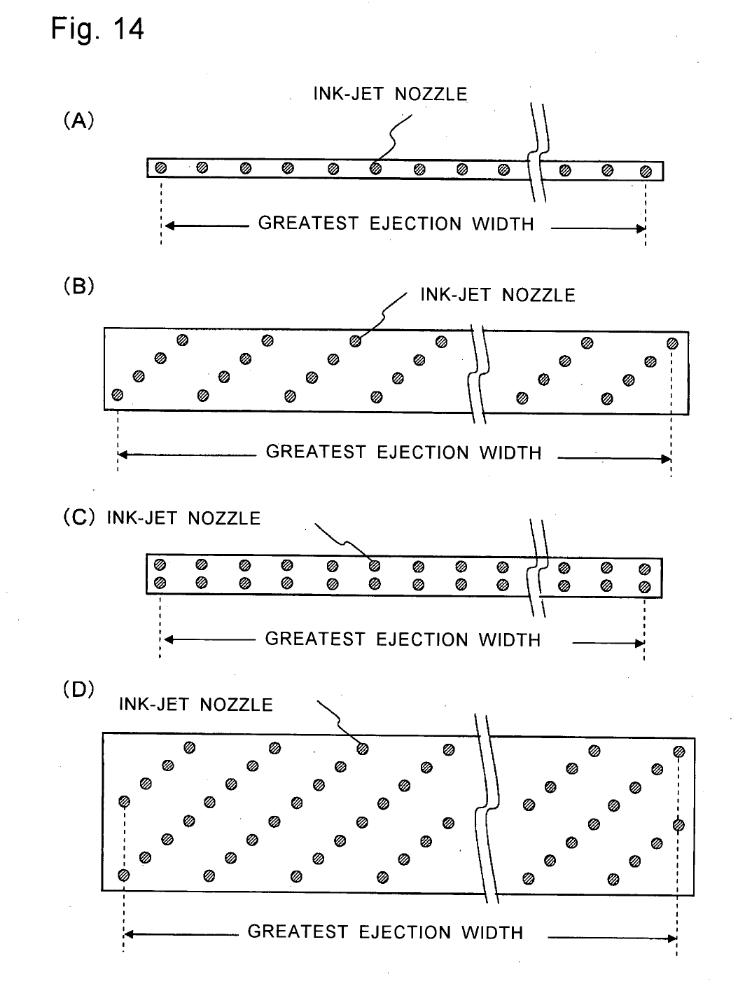

FIG. 13(A) is a view illustrating an exemplary process for applying an UV curable resin in the fabricating method of a multi-layer information recording medium according to the second embodiment of the present invention and FIG. 13(B) is a cross sectional view of FIG. 13(A). A molded resin substrate 101 and a 0-th information recording layer 102 on the molded resin substrate 101 are formed through the method described in the first embodiment. The multi-layer information recording medium fabricating method employs an ink jet head including plural ink jet nozzles. FIGS. 14(A) to (D) illustrate an exemplary ink jet head for use in the fabricating method according to the second embodiment. The ink jet head includes one or more ink jet nozzle rows. In this case, it is assumed that the distance between the ink jet nozzles at the opposite ends is the greatest ejection width of the ink jet head, when viewed in the direction in which the ink jet nozzles are placed at even intervals.

The UV curable resin is applied by controlling the dripping of the UV curable resin from the ink jet nozzles in the ink jet head in such a way as to apply coating to a desired area, while moving at least one of the ink jet head and the molded resin substrate 101.

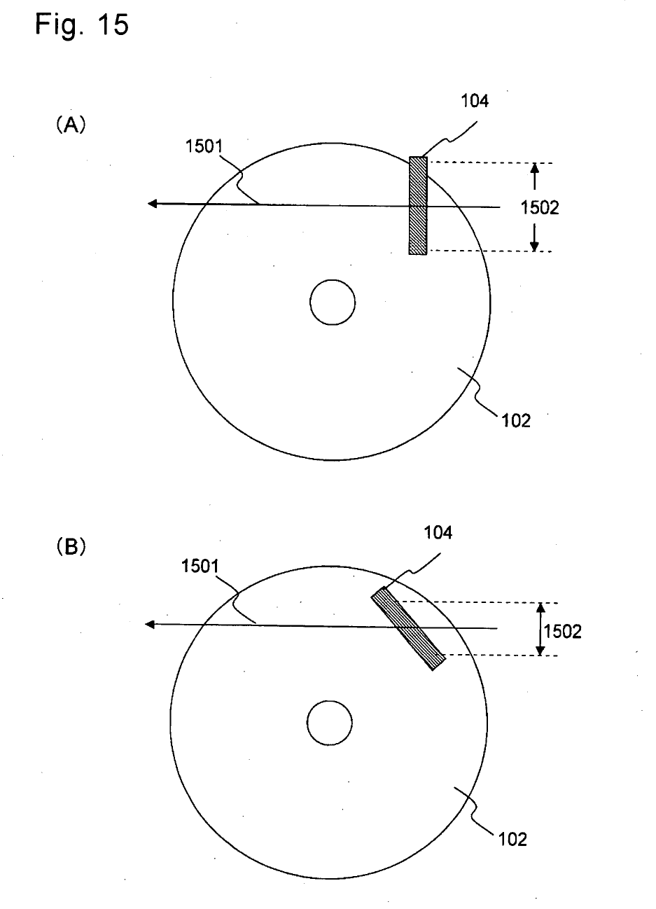

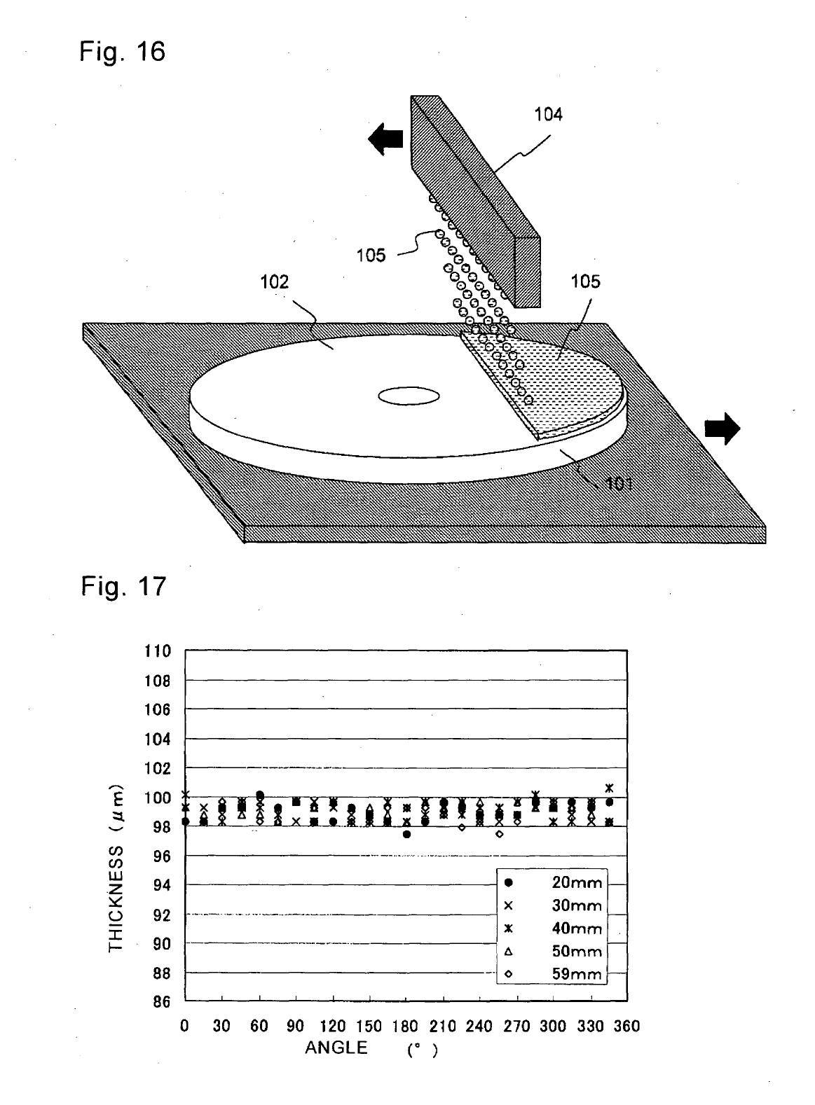

FIGS. 15(A) and (B) illustrate the positional relationship between the ink jet head 104 and the molded resin substrate 101 during applying the resin. If the direction 1501 of movement of the ink jet head 104 relative to the molded resin substrate 101 is made perpendicular to the direction of the greatest ejection width of the ink jet head, this can maximize the effective ejection width 1502 to enable dripping the UV curable resin efficiently, thereby enabling preferably performing the method of the present invention (FIG. 15(A)). On the other hand, if the direction 1501 of movement of the ink jet head 104 relative to the molded resin substrate 101 is set to a direction which is not perpendicular to the direction of the greatest ejection width of the ink jet head, this can reduce the substantial intervals at which the ink jet nozzles are placed during applying the resin according to the present invention. Accordingly, in cases where it is difficult to reduce the intervals of the ink jet nozzles as required in fabricating the ink jet head, the aforementioned case is effective (FIG. 15(B)). The number of times the ink jet head 104 should be scanned is determined from the relationship between the effective ejection width 1502 and the to-be-coated surface. The multi-layer information recording medium to be fabricated through the method of the present invention has a desired to-be-coated surface having a circular shape with a diameter of about 12 cm and, therefore, if the effective ejection width is 30 mm, for example, it is possible to complete the application of coating by scanning the ink jet head 104 four times. Further, as illustrated in FIG. 16, if the effective ejection width is greater than the size of the desired to-be-coated surface, it is possible to complete the application of coating by scanning the ink jet head 104 a single time.

The speed of movement of the ink jet head 104 and the molded resin substrate 101 relative to each other can be properly adjusted depending on the desired coating thickness, but if the speed of movement is excessively large, this will make it impossible to preferably apply the resin due to interruption of the resin film. Accordingly, for example, by controlling the movement speed to a speed which enables dripping liquid drops of the UV curable resin at intervals substantially equal to the substantial intervals at which the ink jet nozzles are placed during applying the UV curable resin according to the present invention, it is possible to preferably apply coating. There will be studied, as an example, a case of employing an ink jet nozzles capable of ejecting minute liquid drops with a volume of 20 pLs and operable at a frequency of 10 kHz. As illustrated in FIG. 14(A) and FIG. 14(B), if an ink jet head having a single ink jet nozzle placed in the direction of movement 1501 when the direction of movement 1501 is perpendicular to the direction of the greatest ejection width is moved such that the direction of movement 1501 is perpendicular to the direction of the greatest ejection width, the moving speed becomes 0.3 m/s. The multi-layer information recording medium to be fabricated through the method of the present invention has a desired to-be-coated surface having a circular shape with a diameter of about 12 cm and, therefore, the coating time required for a single multi-layer information recording medium is a little less than 2 seconds in cases where the coating can be completed by scanning the ink jet head 104 four times, while the coating time is a little less than 0.5 second in cases where the coating can be completed by scanning it a single time. Thus, it is possible to sufficiently reduce the coating time for a single information recording medium. Further, for example, as illustrated in FIG. 14(C) and FIG. 14(D), by employing an ink jet head having two ink jet nozzles arranged in the direction of movement 1501, similarly, it is possible to double the moving speed, thereby shorting the coating time by an amount corresponding thereto. In the same way, it is possible to shorten the coating time with increasing number of ink jet nozzles in the direction of movement 1501.

As previously described, after applying the UV curable resin, an information surface is transferred from a transfer substrate and information recording layers are formed through the same methods as those described in the first embodiment. Also, in the method described in the second embodiment of the present invention, as described in the first embodiment, it is possible to employ plural types of UV curable resins for forming resin intermediate layers, apply an UV curable resin plural times or cure them through an ultraviolet ray or embed additional information members.

In order to form the resin protective layer, an UV curable resin can be applied through the same method as that previously described with respect to the formation of the resin intermediate layer with a thickness of 20 μm and, then, an ultraviolet ray can be applied thereto to cure it without performing processing for transferring an information surface. At this time, as previously described in the first embodiment, the capacity of the ink jet nozzles can be changed or a resin can be applied plural times, according to the thickness of the rein protective layer to be formed.

FIG. 17 illustrates the result of measurements of the thicknesses at respective points within the surface of a four-layered information recording medium fabricated through the method according to the present invention, wherein the four-layered information recording medium includes four information recording layers, three resin intermediate layers with a thickness of 20 μm and a single resin protective layer with a thickness of 40 μm, and the aforementioned thicknesses are the thicknesses from the surface of the information recording medium (the surface of the resin protective layer) to the information recording layer placed at the deepest position, at the respective points, when viewed from the replay-surface side thereof. FIG. 17 shows that the use of the method according to the present invention could sufficiently reduce the variation of the thickness from the surface of the information recording medium (the surface of the resin protective layer) to the information recording layer placed at the deepest position from the replay-surface side to equal to or less than 5 μm, in the case of fabricating the multi-layer information recording medium including the four information recording layers.

Further, while, in the second embodiment, there has been described a case where an information surface has been transferred to the molded resin substrate in advance, even if the molded resin substrate is a simple flat place having no information surface, this will not limit the effects of the present invention, while merely reducing the number of information recording layers by one. Further, while, in the second embodiment, there has been exemplified a case where information recording layers and a resin protective layer are formed on a single side of a molded resin substrate, the fabricating method according to the present invention can be utilized for forming information recording layers and a resin protective layer on the both sides of a molded resin substrate as illustrated in FIG. 18. In this case, an information surface can be formed on each of the sides of the molded resin substrate during the molding thereof. Also, it is possible to attach two molded resin substrates each having an information surface formed on its one side to each other, at their sides having no information surface. Further, the method according to the present invention can be used in cases where no information surface is not formed on one or both of the molded resin substrates.

Although there have been described in detail preferable embodiments of the present invention, the present invention is not intended to be limited to these embodiments. It will be apparent to those skilled in the art that various preferable variations and modifications can be made within the technical scope of the present invention defined in the claims.

The apparatus and the method for fabricating a multi-layer information recording medium according to the present invention are advantageously employed in fabricating methods of recording mediums including plural information surfaces, such as optical disks. Also, the method and the apparatus can be advantageously employed in fabricating methods of multi-layer information recording mediums required to have excellent thickness accuracy, as well as information recording mediums which enable recording and replaying information therein and therefrom along with the rotation thereof, such as optical discs.

1-20. (canceled)

21. An apparatus for fabricating a multi-layer information recording medium including a substrate, plural information recording layers placed on said substrate, resin intermediate layers placed between adjacent information recording layers and a resin protective layer placed on all the information recording layers at the side opposite from said substrate, said apparatus comprising:
an ejecting unit including ink jet nozzles operable to drip minute resin liquid drops onto said substrate or said information recording layers; and
a control unit operable to control the ejecting unit, such that the ejecting unit is moved along a relative moving direction, wherein the relative moving direction is parallel to a diameter of the substrate;
whereby resin layers which form said resin intermediate layers or said resin protective layer are formed on said substrate or said information recording layers.

22. The apparatus for fabricating a multi-layer information recording medium according to claim 21, wherein the ejecting unit is moved perpendicularly to a direction of a greatest ejection width of the ejecting unit.

23. An apparatus for fabricating a multi-layer information recording medium including a substrate, plural information recording layers placed on said substrate, resin intermediate layers placed between adjacent information recording layers and a resin protective layer placed on all the information recording layers at the side opposite from said substrate, said apparatus comprising:
a rotating unit operable to rotate said substrate;
an ejecting unit including ink jet nozzles operable to drip minute resin liquid drops onto said substrate or said information recording layers; and
a control unit operable to control said electing unit,
wherein said control unit controls said rotating unit to control the rotation speed (with a unit of rpm) of said substrate to equal to or less than five times the viscosity (with a unit of m-Pa) of said resin,
whereby resin layers which form said resin intermediate layers or said resin protective layer are formed on said substrate or said information recording layers.

24. The apparatus for fabricating a multi-layer information recording medium according to claim 23, wherein said ejecting unit includes plural ink jet nozzles, which are located along a line of equal length between the inside and the outside of the substrate.

25. The apparatus for fabricating a multi-layer information recording medium according to claim 24, wherein said ejecting unit is configured such that the density of ink jet nozzles near the outside of the substrate is greater than that near the inside of the substrate.

26. The apparatus for fabricating a multi-layer information recording medium according to claim 24, wherein said ejecting unit is configured such that the ink jet nozzles placed near the outside of the substrate eject greater amounts of resin than those placed near the inside of the substrate.

27. The apparatus for fabricating a multi-layer information recording medium according to claim 23, wherein said ejecting unit has a greatest ejection width between the inside and the outside of the substrate, the greatest ejection width being equal to or greater than the diameter of the information recording layers on the substrate.

28. The apparatus for fabricating a multi-layer information recording medium according to claim 23, wherein said control unit determines the amount of ejection from said ejecting unit, according to the radius value of the location of the substrate onto which the ejecting unit drips minute resin liquid drops.

29. A method for fabricating a multi-layer information recording medium including a substrate, plural information recording layers placed on said substrate, resin intermediate layers placed between adjacent information recording layers and a resin protective layer placed on all the information recording layers at the side opposite from said substrate, the method comprising:
moving at least one of said substrate and said ejecting unit along a relative moving direction, wherein the relative moving direction is parallel to a diameter of the substrate; and
dripping minute resin liquid drops from an ejecting unit including ink jet nozzles onto said substrate or said information recording layers, while moving the substrate or the ejecting unit, to apply the resin thereto to form resin layers corresponding to the resin intermediate layers or the resin protective layer.

30. The method for fabricating a multi-layer information recording medium according to claim 29, wherein the ejecting unit is moved perpendicularly to a direction of a greatest ejection width of the ejecting unit.

31. A method for fabricating a multi-layer information recording medium including a substrate, plural information recording layers placed on said substrate, resin intermediate layers placed between adjacent information recording layers and a resin protective layer placed on all the information recording layers at the side opposite from said substrate, the method comprising:
moving at least one of said substrate and said ejecting unit to spirally move said ejecting unit over said substrate relative to said substrate,
controlling the rotation speed (with a unit of rpm) of said substrate to equal to or less than five times the viscosity (with a unit of m-Pa) of said resin,
dripping minute resin liquid drops from an ejecting unit including ink jet nozzles onto said substrate or said information recording layers, while moving the substrate or the ejecting unit, to apply the resin thereto to form resin layers which are said resin intermediate layers or said resin protective layer.

32. The method for fabricating a multi-layer information recording medium according to claim 31, further comprising:
determining the amount of ejection from said ejecting unit, according to the radius value of the location of the substrate onto which the ejecting unit drips minute resin liquid drops.

33. The method for fabricating a multi-layer information recording medium according to claim 32, further comprising:
increasing the amount of ejection from said ejecting unit with increasing radius value of the location of the substrate onto which the ejecting unit drips minute resin liquid drops.

34. The method for fabricating a multi-layer information recording medium according to claim 31, wherein the dripping step includes a plurality of dripping steps.

35. The method for fabricating a multi-layer information recording medium according to claim 34, wherein the resins used in the dripping step include a plurality types of resins.

36. The method for fabricating a multi-layer information recording medium according to claim 31, further comprising:
embedding additional information members in said resin layers, with at least one of the timings before, during and after applying the resin which mainly constitutes said resin layers.

37. The method for fabricating a multi-layer information recording medium according to claim 36, wherein different additional information members are embedded in said respective resin layers, when there are plural said resin layers.
